(19) United States
(12) Patent Application Publication
(10) Pub. No.: US 2023/0378733 A1
(43) Pub. Date: Nov. 23, 2023

(54) Adjustable-Depth Electrical Boxes

(71) Applicant: ERICO International Corporation, Solon, OH (US)

(72) Inventors: Michael Hung Sun Oh, Twinsburg, OH (US); James Anthony Bukowski, Akron, OH (US)

(21) Appl. No.: 18/318,992

(22) Filed: May 17, 2023

Related U.S. Application Data
(60) Provisional application No. 63/344,715, filed on May 23, 2022.

(51) Int. Cl. H02G 3/12

(52) U.S. Cl. CPC H02G 3/12

(57) ABSTRACT

An electrical-box-and-bracket that can include a bracket including a support body, with a bracket opening, and first and second support arms extending from the support body on opposing sides of the bracket opening. An electrical box can have a front opening and can be positioned within the bracket opening. The assembly can further include a set of adjustable fasteners, including first and second box adjustment fasteners and an adjustable far side support. The first and second box adjustment fasteners can extend through a rear wall of the electrical box and to the first and second support arms and can be accessible for selectively adjusting the distance between the bracket opening of the bracket and the front opening of the electrical box. The adjustable far side support can extend through the rear wall of the electrical box and can be accessible for adjustably supporting the electrical box.

### CROSS-REFERENCE TO RELATED APPLICATIONS

This application claims priority under 35 U.S.C. 119 from U.S. Provisional Application No. 63/344,715, filed May 23, 2022, titled “Adjustable-Depth Electrical Boxes,” and is incorporated herein by reference in its entirety.

### BACKGROUND

In many applications, it may be useful to support electrical boxes at different depths relative to support structures, for example, wall structures of buildings. In some cases, it may be useful to support the electrical boxes at different depths relative to a particular support structure to provide a flush alignment with the front of the box and an outer surface of the wall structure.

### SUMMARY

Some embodiments of the invention provide an electrical-box-and-bracket assembly. The electrical-box-and-bracket assembly can include a bracket including a support body, with a bracket opening, and first and second support arms extending from the support body on opposing sides of the bracket opening. An electrical box can have a front opening and can be positioned within the bracket opening. The assembly can further include a set of adjustable fasteners, including first and second box adjustment fasteners and an adjustable far side support. The first and second box adjustment fasteners can extend through a rear wall of the electrical box and to the first and second support arms. The first and second box adjustment fasteners can be accessible for selectively adjusting the distance between the bracket opening of the bracket and the front opening of the electrical box. The adjustable far side support can extend through the rear wall of the electrical box and can be accessible for adjustably supporting the electrical box.

Some embodiments of the invention provide an electric-box-and-bracket assembly. The electrical-box-and-bracket assembly can include an electrical box having a rear wall with a set of threaded holes therein. The assembly can further include a bracket with a mounting flange for affixing the bracket to a support structure and a set of threaded fasteners. The set of threaded fasteners can include a first threaded fastener extending through a first threaded hole of the set of threaded holes and can also be engaged with the bracket to adjust a depth of the electrical box relative to the bracket. The set of threaded fasteners can also include a second threaded fastener extending through a second threaded hole of the set of threaded holes and can be configured to adjustably support a side of the electrical box opposite the mounting flange.

Some embodiments of the invention provide a method of attaching an electrical-box-and-bracket assembly, including an electrical box and a bracket, to a support structure. The method can include affixing a mounting flange of the bracket to the support structure; adjusting the electrical box relative to the support structure by rotating a threaded fastener engaged between the electrical box and the bracket; and adjusting an adjustable far side support to contact an opposing wall support covering to support a side of the electrical box distal to the support structure by rotating a second threaded fastener.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a front top right isometric view of an electrical box and a support bracket according to an embodiment of the invention;

FIG. 2 is a rear top left isometric view of the electrical box and the support bracket of FIG. 1;

FIG. 3 is a left elevation view of the electrical box and the support bracket of FIG. 1;

FIG. 4 is a right elevation view of the electrical box and support bracket of FIG. 1;

FIG. 5 is a front elevation view of the electrical box and the support bracket of FIG. 1;

FIG. 6 is a top plan view of the electrical box and the support bracket of FIG. 1;

FIG. 7 is a front elevation view of the electrical box and the support bracket of FIG. 1 with electrical devices installed within the electrical box according to an embodiment of the invention;

FIG. 8 is a top plan view of the electrical box and the support bracket of FIG. 1 installed within a wall space according to an embodiment of the invention;

FIG. 9 is a top plan view of the electrical box and the support bracket of FIG. 1 installed within another wall space according to an embodiment of the invention;

FIG. 10 is a top plan view of the electrical box and the support bracket of FIG. 1 installed within another wall space according to an embodiment of the invention;

FIG. 11 is a top plan view of the electrical box and the support bracket of FIG. 1 installed within another wall space according to an embodiment of the invention;

FIG. 12 is a rear top left isometric view of an electrical box and a support bracket according to another embodiment of the invention; and

FIG. 13 is a diagram of a method according to an embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, unless otherwise specified or limited, directional terms are presented only with regard to the particular embodiment and perspective described. For example, reference to features or directions as “horizontal,” “vertical,” “front,” “rear,” “left,” “right,” and so on are generally made with reference to a particular figure or example and are not necessarily indicative of an absolute orientation or direction. However, relative directional terms for a particular embodiment may generally apply to alternative orientations of that embodiment. For example, “front” and “rear” directions or features (or “right” and “left” directions or features, and so on) may be generally understood to indicate relatively opposite directions or features.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

As noted above, in some contexts, it may be useful to secure electrical boxes (or other components) at different depths relative to a support structure. For example, in order to comply with requirements that a front opening of an electrical box, in which, for example, electrical devices can be secured, be flush with an outward facing surface of a wall support covering (e.g., drywall, wood, tile, or a combination thereof), the electrical box may need to be secured to a support structure (e.g., a wall stud, support bracket, etc.) at a depth that depends on the depth of the wall support covering. Because wall support coverings can be provided with a variety of depths, it may accordingly be necessary to adjust the depth of an electrical box relative to a particular support structure and the wall support covering(s) to bring the front opening of the electrical box flush with the wall support covering.

Additionally, support structures (e.g., a wall stud) can have different depths and can be formed from materials, such as, for example wood or metal. Some support structures can have a depth dimension of 2½″, 3½″, 3⅝″, 4″, 5½″, 6″, among others. Embodiments of the invention can provide a bracket with a mounting flange that can be secured to a face of a wall stud to support the electrical box therefrom. Further, the electrical box can have an adjustable far side support positioned opposite the mounting flange and configured to be adjusted to contact a wall surface covering that is opposite the front opening of the electrical box to urge the front opening on the far side of the electrical box (i.e., the side opposite the mounting flange) to be flush with the adjacent wall support covering and prevent the far side of the electrical box from being pushed into the wall cavity.

Further, associated methods for allowing easy adjustment of the mounting depth of an electrical box relative to a support structure and shoring up the far side of the electrical box are also contemplated by the proposed electrical box and bracket assembly. In some embodiments, the methods for doing so can be performed after the bracket and the electrical box have been installed on the support structure and wall support coverings have been installed.

Embodiments of the invention are presented below in the context of particular support structures, including stud-framed walls. Although these configurations can be particularly useful in some contexts, including due to the particular requirements for mounting electrical boxes to a wall stud, other configurations are possible. For example, the principles disclosed herein—and embodiments of the invention—can be used with support structures other than those expressly illustrated or discussed, with mounting structures (e.g., telescoping or other brackets attached to and between wall studs), or in a variety of other contexts. Similarly, although particular configurations of electrical boxes are illustrated and discussed below, some embodiments of the invention can be used with electrical boxes having different configurations (e.g., more or less gangs). And some embodiments of the invention can be used to adjust the mounting depth of components other than electrical boxes.

Generally, embodiments of the invention can include a bracket that includes a support body and one or more support arms that are collectively configured to support an electrical box relative to a support structure (e.g., a wall stud). In some cases, the support arm(s) can be integrally formed with the support body, although other configurations are possible.

Each support arm can be configured to adjustably receive a fastener, with the fastener extending from the support arm to engage the support body or the electrical box. The fastener can then be adjusted relative to the support arm in order to manually adjust the mounting depth of the electrical box relative to the support body and any associated support structure (e.g., a wall stud). Generally, in this regard, adjustment of the fastener can move the electrical box in an axial direction defined by the fastener, relative to at least one of the support body or the associated support arm.

In some embodiments, the fastener can be a ribbed fastener, such as a fastener with threads or circumferential ridges. For example, some embodiments can include a threaded fastener that is rotatable but not translatable relative to the associated support arm. The threaded fastener can accordingly be rotated by a user in order to cause a translational adjustment of the electrical box. For example, rotation of a threaded fastener may cause translational movement of an electrical box via engagement with a threaded fastener opening on the electrical box or on the support body.

In some embodiments, it may be useful to arrange the support body and the one or more support arms so that one or more associated fasteners extend within the interior of the electrical box. In some such embodiments, the fasteners may be adjustable from within the electrical box. For example, a support arm may rotatably and non-translatably secure a threaded fastener that extends from the support arm through a threaded fastener opening on the electrical box into the interior of the electrical box. A user can then engage a head of the fastener from within the electrical box, thereby rotating the fastener to cause the electrical box to be translated relative to the support arm via the threaded engagement of the fastener with the fastener opening and the non-translatable engagement of the fastener with the support arm.

The ability to adjust the mounting depth of an electrical box by engaging a fastener within the interior of the electrical box may be useful, for example, in order to facilitate easier adjustment of the electrical box after a wall covering (e.g., drywall, wood-paneling, tile, etc.) has been installed.

Additionally, or alternatively, embodiments of the invention can include an adjustable far side support that includes a fastener (e.g., a threaded fastener) with a foot. In some embodiments, the fastener can be rotatable and translatable relative to the electrical box. The fastener can extend through a threaded opening on the electrical box and into the interior of the electrical box. A user can engage a head of the fastener from within the electrical box, thereby rotating the fastener to cause the adjustable far side support to be translated relative to the electrical box via the threaded engagement of the fastener with the fastener opening. The threaded fastener can accordingly be rotated by a user to cause the foot to contact an opposing wall support covering and further rotation urges the far side (i.e., the side of the electrical box farthest from the attachment of the support bracket to the wall support) of the electrical box away from the opposing wall support covering. Generally, in this regard, adjustment of the fastener can move the electrical box in an axial direction defined by the fastener, relative to the wall support and the wall support coverings.

In some embodiments, it may be useful to arrange the adjustable far side support so that the fastener extends within the interior of the electrical box. In some such embodiments, the fastener may be adjustable from within the electrical box. The ability to adjust the far side depth of an electrical box by engaging a fastener within the interior of the electrical box may be useful, for example, in order to facilitate easier adjustment and securement of the electrical box after a wall covering (e.g., drywall, wood-paneling, tile, etc.) has been installed.

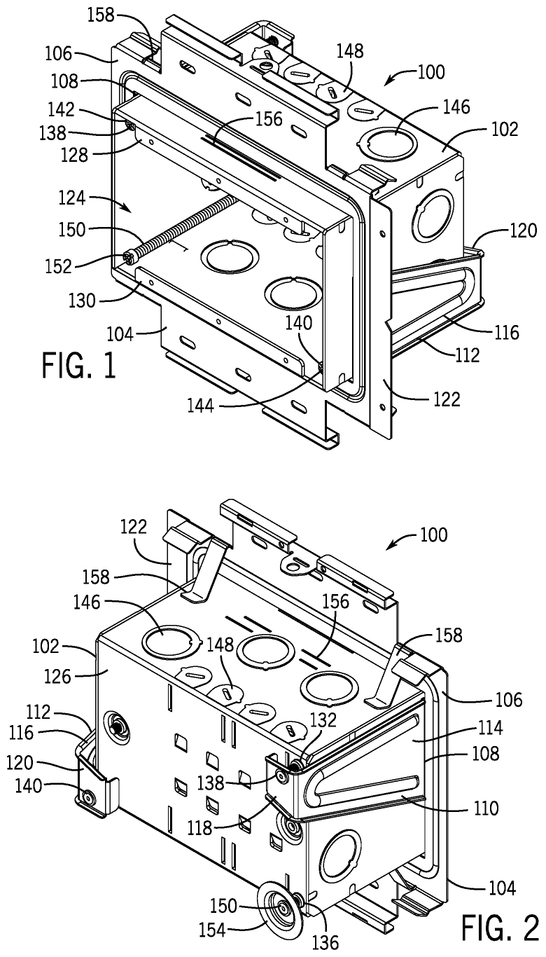

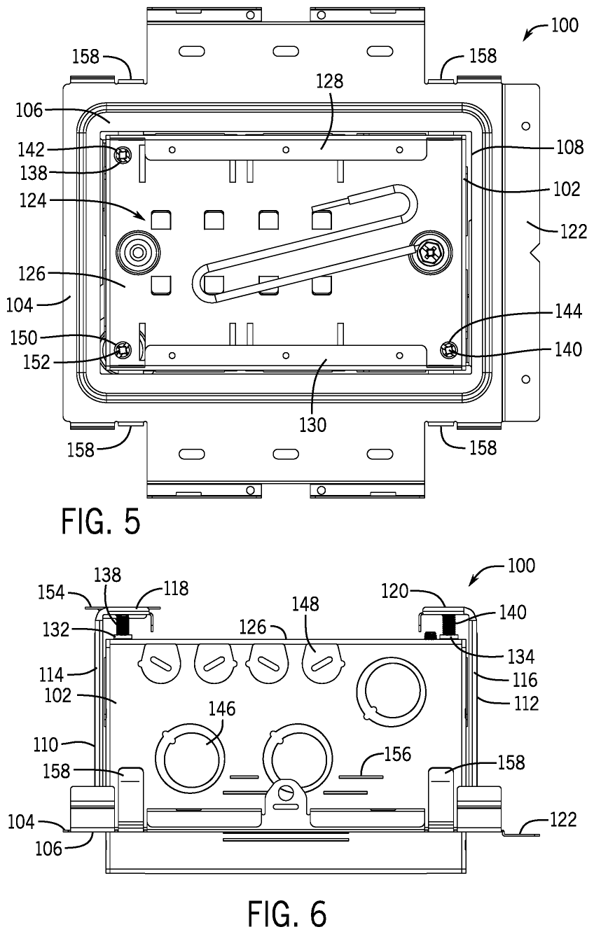

Referring to FIGS. 1 through 6, an example electrical box and bracket assembly 100 is shown according to an embodiment of the invention. In the illustrated example, the electrical box and bracket assembly 100 includes an electrical box 102 and a bracket 104. The bracket 104 has a support body 106 with a bracket opening 108 configured to receive the electrical box 102 therein and therethrough. This can provide for easy installation of the electrical box 102 and relatively stable support thereof. In other embodiments, however, other configurations are possible, including configurations in which a support body does not fully surround exterior sides of an electrical box.

A set of support arms (here shown as a first support arm 110 and a second support arm 112) extend from opposing corners of the support body 106. In the illustrated embodiment, the support arms 110, 112 are integrally formed with the support body 106 and extend adjacent the bracket opening 108, in particular from a connection to the support body 106 at an edge of the bracket opening 108. This may allow the bracket 104 to be manufactured with particular efficiency, although other configurations are possible. As illustrated in FIGS. 1 through 6, each of the support arms 110, 112 includes an extension portion 114, 116 that extends rearwardly (i.e., away from the bracket opening 108), and adjacent respective exterior sides of the electrical box 102. Each of the support arms 110, 112 also includes a support portion 118, 120, which projects inward from the respective extension portion 114, 116. In other embodiments, however, other configurations are possible.

Additionally, to further guide movement of the electrical box 102 during depth adjustment, the bracket 104 can also include guide tabs 158 extending from the support body 106. As illustrated in FIG. 2, in particular, the guide tabs 158 extend integrally from the support body 106 and overlap with a rearward projection of the area of the bracket opening 108. Accordingly, when the electrical box 102 is slidingly disposed within the bracket opening 108, the guide tabs 158 resiliently engage the corresponding side walls of the electrical box 102 and thereby assist to maintain an aligned and smooth movement of the electrical box 102 within the bracket opening 108 during depth adjustment. Thus, in the illustrated embodiment, the electrical box 102 can be laterally stabilized on all four sides, by a combination of the first and second support arms 110, 112 and the guide tabs 158, so that relatively smooth adjustment and stable anchoring of the electrical box 102 can be achieved.

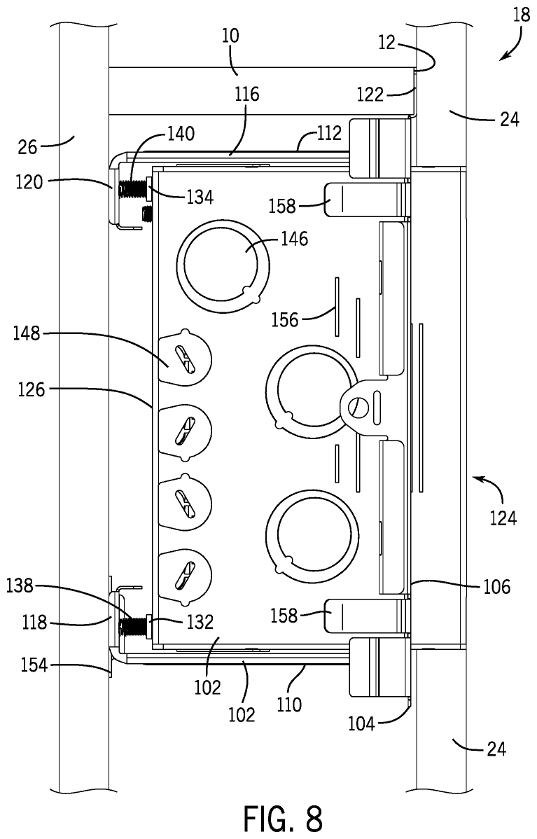

The bracket 104 also includes a mounting flange 122 extending along one side of the support body 106. The mounting flange 122 is configured to be positioned along a front face of a wall support member (e.g., a wall stud 10 with a front face 12 as shown in FIG. 8) and secured thereto with fasteners (not shown) to attach the bracket 104 to the wall stud 10.

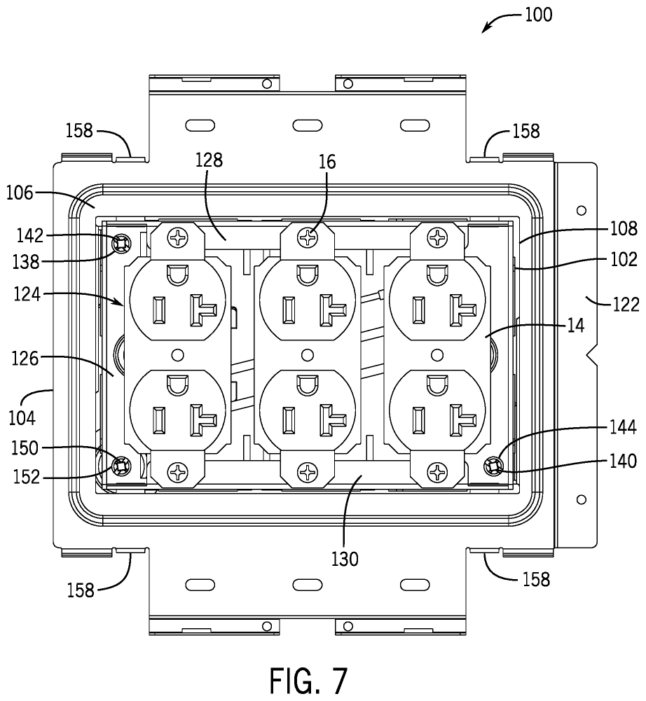

The electrical box 102 includes a front opening 124 and a rear wall 126 opposite the front opening 124. Top and bottom mounting tabs 128, 130 extend inward into the front opening 124 and are configured to receive fasteners to secure electrical devices to the electrical box 102 (e.g., electrical receptacles 14 and fasteners 16 shown in FIG. 7).

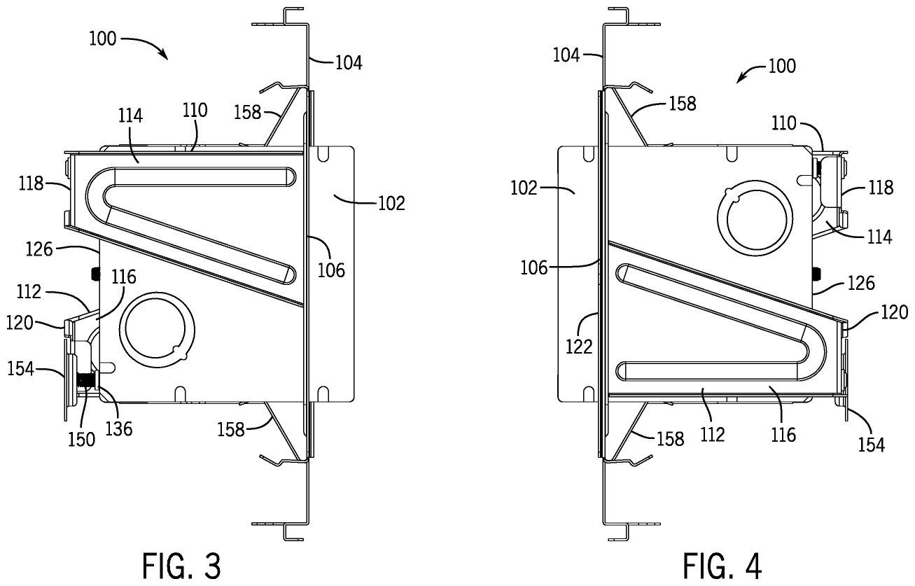

Additionally, the rear wall 126 has a plurality of threaded holes (e.g., a first threaded hole 132, a second threaded hole 134, and a third threaded hole 136 shown in FIGS. 2 and 3) extending therethrough. The first and second threaded holes 132, 134 are located on diagonally opposite corners of the rear wall 126 (i.e., at corners not included on a common edge of the rear wall 126) and in alignment with the support portions 118, 120 of the first and second support arms 110, 112 when the electrical box 102 is positioned within the bracket opening 108.

The first and second box adjustment fasteners 138, 140 can extend from the support portions 118, 120 of the respective first and second support arms 110, 112. For example, the first and second box adjustment fasteners 138, 140 can be rotatable relative to the support portions 118, 120 but can be translationally (axially) fixed relative to the support portions 118, 120 (e.g., via riveting or peening of the fasteners, use of E-, C-, or other clips, use of integral or removable collars, or other techniques). The first and second box adjustment fasteners 138, 140 are threadedly engaged with threads in the first and second threaded holes 132, 134 on the rear wall 126 of the electrical box 102. Accordingly, when the first and second box adjustment fasteners 138, 140 are rotated, the threaded engagement of the first and second box adjustment fasteners 138, 140 with the first and second thread holes 132, 134, and the rotatable but non-translational engagement of the first and second box adjustment fasteners 138, 140 with the support portions 118, 120, can collectively cause the electrical box 102 to move axially along the first and second box adjustment fasteners 138, 140. Thus, via rotation of the first and second box adjustment fasteners 138, 140 and corresponding axial movement of the first and second box adjustment fasteners 138, 140 through the first and second threaded holes 132, 134, the electrical box 102 can be secured at any of a plurality of depths relative to the support body 106. Indeed, because of the threaded configuration of the first and second box adjustment fasteners 138, 140, the electrical box 102 can be secured at any box depth, defined as the distance between either the top or bottom mounting tab 128, 130 and the support body 106, along a continuous range further limited only by the available length of the first and second box adjustment fasteners 138, 140.

Alternatively, the first and second box adjustment fasteners 138, 140 can be configured to abut the support portions 114, 116 and extend into the electrical box 102 through the first and second threaded holes 132, 134. Adjustment of the first and second box adjustment fasteners 138, 140 relative to the first and second support arms 110, 112 and against the respective support portions 118, 120 can thereby adjust the mounting depth of the electrical box 102.

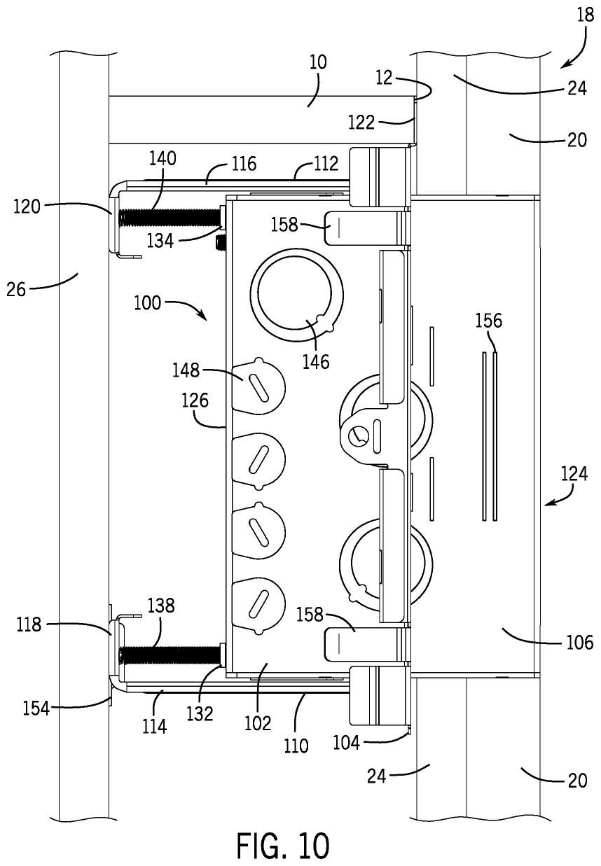

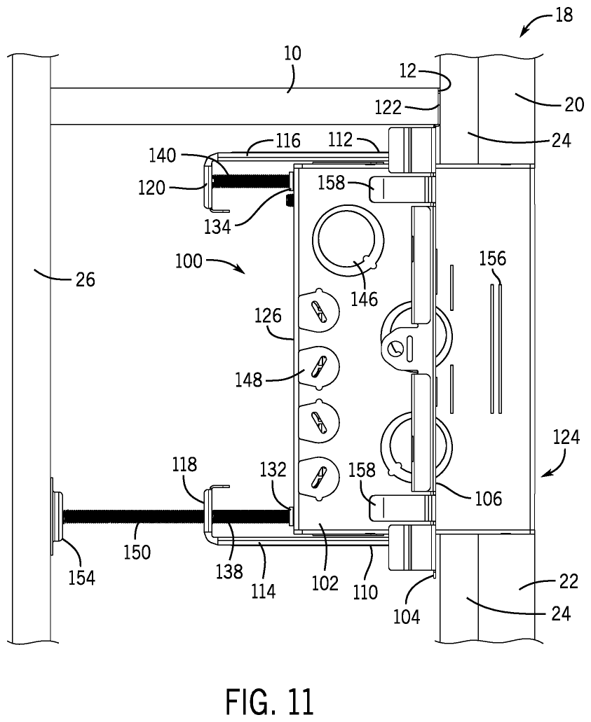

Depth adjustment of the electrical box 102 from within the electrical box 102 through the front opening 124 can be advantageous to ensure the top and bottom mounting tabs 128, 130 of the electrical box 102 are flush with the wall support covering 18 when finishing an installation. For example, in some construction scenarios, additional layers of wall support coverings may be installed (e.g., tile 20 (shown in FIG. 10) or wood paneling 22 (shown in FIG. 11)) on top of a layer of drywall 24 (shown in FIGS. 8 through 11), which may require adjustment of the electrical box 102 after initial installation of the electrical box 102 and after the installation of the wall support coverings 18. In certain scenarios in which a combustible wall support covering such as, for example, wood paneling is added, extension rings (not shown) would be required to be installed to extend the depth of the electrical box 102 to be flush with the outer surface of the wall support covering 18 to prevent the possibility of a spark from an electrical device (e.g., electrical receptacles 14 shown in FIG. 7) or wiring connections within the electrical box 102 from igniting the wood paneling. The ability to adjust the depth of the electrical box 102 relative to the wall support covering 18 eliminates the need to install extension rings. Further, as shown in FIG. 7, the first and second box adjustment fasteners 138, 140 are accessible even after electrical devices, such as, for example, the electrical receptacles 14 are installed.

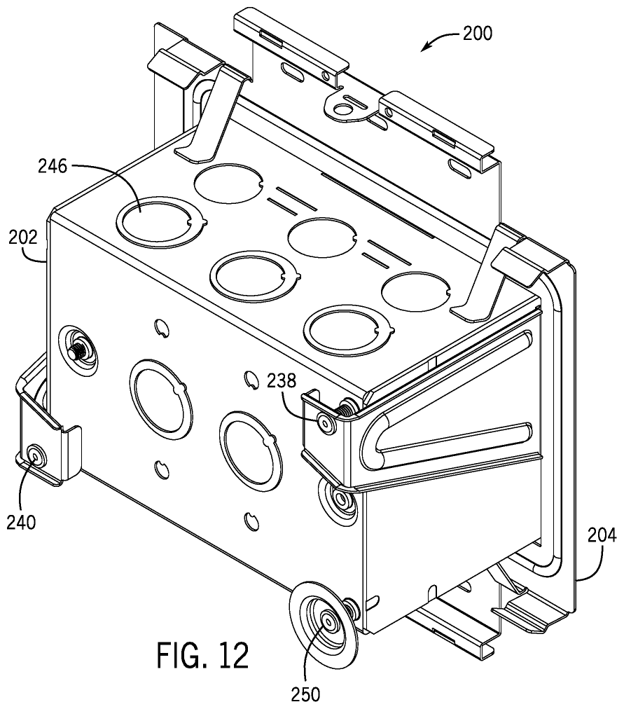

Additionally, the diagonally opposite corner placement of the first and second threaded holes 132, 134 and the first and second support arms 110, 112 allows the electrical box 102 to be rotated 180 degrees relative to the bracket 104 to position knockouts 146 and/or cable entry points 148 (e.g., for the installation of metal-clad cable or other types of raceways or cable systems) in a desired location relative to the wall stud 10 when mounting the electrical box and bracket assembly 100 on either side of the wall stud 10. Although a certain pattern of knockouts 146 and cable entry points 148 is shown in the figures, it should be understood that other patterns are contemplated, including electrical boxes having only knockouts (shown in FIG. 12) and electrical boxes having only cable entry points. As also generally discussed below, the diagonally opposite corner placement of the first and second threaded holes 132, 134 may help to provide even, easy, and reliable adjustment of the depth of the electrical box 102 while also helping to prevent the first and second box adjustment fasteners 138, 140 from unduly interfering with wires or electrical devices (e.g., the electrical receptacles 14 shown in FIG. 7) within the electrical box 102.

In some embodiments, a minimum box depth and a maximum box depth can be provided. As discussed above, the box depth is defined as the distance between either the top or bottom mounting tab 128, 130 and the support body 106. For example, an electrical box and bracket assembly can be configured to have a minimum box depth of 0.5 inch and a maximum box depth of 1.5 inches. With the electrical box 105 positioned at the minimum box depth, the heads 142, 144 of the first and second box adjustment fasteners are configured to not extend out of the front opening 124 beyond the top and bottom mounting tabs 128, 130. In some embodiments, visual depth indicators 156 can be provided on the electrical box 102 to indicate the box depth of the electrical box 102. The visual depth indicator 156 can provide both a marker line and a unit of measurement next to the marker line. For example, when a mark line of a visual depth indicator 156 is in alignment with the support body 106 of the bracket 104, the box depth is the distance indicated next to the marker line. In some embodiments, visual indicators 156 can be provided for box depths of ½″, ⅝″, 1¼″, and 1½″ depths. In some embodiments, these or other box depths can be provided in either or both English and Metric units.

As discussed herein, unless otherwise indicated, the phrase “translationally fixed” and the like does not necessarily indicate an absolutely fixed arrangement, in which zero translational movement is permitted. Rather, some translationally fixed components (e.g., the first and second box adjustment fasteners 138, 140) may be able to move translationally somewhat, but only to a certain amount and generally not so as to provide meaningful translational adjustment of a corresponding component (e.g., the electrical box 102). For example, depending on how the first and second box adjustment fasteners 138, 140 are fixed to the support portions 118, 120, the first and second box adjustment fasteners 138, 140 may be able to move slightly in the axial direction, relative to the support portions 118, 120 (e.g., by 1-5 mm or 1-3% of the axial length of the first and second box adjustment fasteners 138, 140 or of the total depth of the electrical box 102).

Continuing to look at the electrical box and bracket assembly 100 as shown in FIGS. 1 through 6, an adjustable far side support 150 is shown. The third threaded hole 136, located in a corner of the electrical box 102 not occupied by the first or second threaded holes 132, 134 and opposite the mounting flange 122, is configured to receive the adjustable far side support 150 therein. The adjustable far side support 150 is configured to abut the opposing wall support covering 26 (i.e., the wall support covering opposite the front opening 124 of the electrical box 102) and extend into the electrical box 102. Adjustment of the adjustable far side support 150 relative to the electrical box 102 and against the opposing wall support covering 26 can adjust the far side of the electrical box 102 (i.e., the side of the electrical box 102 opposite the mounting flange 122). For example, a user can engage a head 152 of the adjustable far side support 150 from within the electrical box 102 and rotate the adjustable far side support 150 to cause the far side of the electrical box 102 to be translated relative to the wall support covering 18 via the threaded engagement of the adjustable far side support 150 with the third threaded hole 136 and contact with the opposing wall support covering 26.

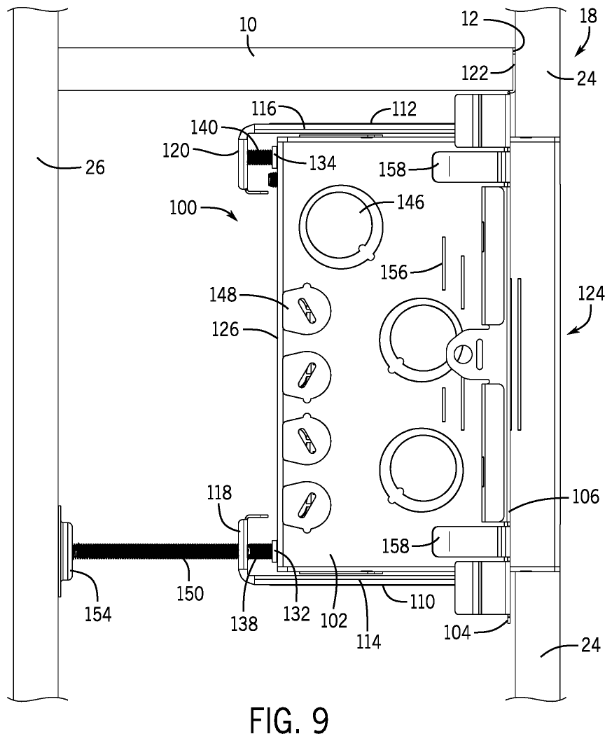

Adjustment of the far side of the electrical box 102 from within the electrical box 102 through the front opening 124 can be advantageous to ensure the far side of the electrical box 102 is flush with the wall support covering 18 when finishing an installation and also adequately secured against being pushed into the wall space. For example, in some construction scenarios, the wall cavity depth can vary depending on the type of wall on which the electrical box and bracket assembly 100 are installed (e.g., interior wall versus exterior wall). Continuing with the example, an interior wall may be constructed with studs (wood or metal) with depth dimensions of 2½″, 3½″, 3⅝″, or 4″ (examples shown in FIGS. 8 and 10) while an exterior wall can be constructed with studs (wood or metal) with depth dimensions of 5½″ or 6″ (examples shown in FIGS. 9 and 11). Therefore, the adjustable far side support 150 must be adjustable to accommodate wall cavities of different depths.

Additionally, the adjustable far side support 150 can have a foot 154, opposite the head 152, configured to engage the opposing wall support covering 26. For example, the foot 154 as shown in FIGS. 2 and 9, has a circular shape that has an outer diameter significantly larger than the cross-sectional area of the threaded portion of the adjustable far side support 150. The larger area of the foot 154 spreads the force of tightening the adjustable far side support 150 over a larger area of the opposing wall support covering 26, which allows more tightening force to be applied by the adjustable far side support 150 without breaking through (e.g., puncturing) the opposing wall support covering 26. It is contemplated that the foot 154 can be formed in shapes other than circular (e.g., rectangular, triangular, etc.) and may contain grip enhancing features (e.g., spikes (not shown)) extending therefrom.

Additionally, in some embodiments, it is contemplated that in some installation scenarios the support arms can provide distributed (and changeable) points of support against an opposing wall support. For example, as shown in FIG. 10, with the electrical box and bracket assembly 100 installed in a wall space with a depth dimension of 2½″, the support portions 118, 120 of the first and second support arms 110, 112 contact the opposing wall support covering 26 and provide support of the electrical box 102 within the wall space. The support provided by the first and second support arms 110, 112 can be used in addition to the adjustable far side support 150 to provide three points of support or can be used alternatively to the adjustable far side support 150 to provide two, diagonally spaced, points of support. In other embodiments, other configurations are possible, for example, the support arms can be configured to provide points of support in a wall depth that is shallower or deeper than 2½″. Further, in structures with deeper wall depths, the far side support 150 can provide a single point of support, spaced rearward of the support arms 110, 112 (see, e.g., FIG. 11).

In some embodiments, other aspects of the configuration illustrated in FIGS. 1 through 6 can also be changed while preserving similarly beneficial adjustability. For example, in some embodiments, fasteners may be translationally fixed relative to a support arm and may engage a threaded feature at a different location on or in an electrical box. Or a fastener threadedly engaged with a support arm and translationally fixed but rotatable relative to an electrical box. Similarly, although configurations with a set of opposing support arms (e.g., at opposing corners) may sometimes provide a particularly optimal balance between stability and ease of adjustment, some configurations may have a different number of support arms, or one or more support arms disposed differently relative to a support body than is illustrated in FIGS. 1 through 6.

FIG. 12 illustrates another embodiment of an electrical box and bracket assembly 200 according to the invention, as also can be secured to a support structure (e.g., a wall stud 10 as shown in FIG. 8). In many aspects, the electrical box and bracket assembly 200 is similar to the electrical box and bracket assembly 100 described above and similar numbering in the 200 series is used for the electrical box and bracket assembly 200. For example, the electrical box and bracket assembly 200 has an electrical box 202, a bracket 204, first and second box adjustment fasteners 238, 240, and an adjustable far side support 250, wherein the electrical box 202 is configured to be moved relative to the bracket 204 by rotating the first and second box adjustment fasteners 238, 240 and the adjustable far side support 250 is configured to be rotated to contact an opposing wall support covering (not shown)

In some aspects, however, the electrical box and bracket assemblies 100, 200 differ from each other. For example, the electrical box 202 has only knockouts 246 (i.e., no other types cable entry points). As shown, the knockouts 246 are located symmetrically on the electrical box 202, which allows the electrical box 202 to be rotated 180 degrees relative to the bracket 204 and maintain the position of the knockouts 246 in the same location relative to a wall stud (e.g., the wall stud 10 shown in FIGS. 8 through 11), for example when mounting the electrical box and bracket assembly 200 to either side of the wall stud 10. In other embodiments, other knockout locations are contemplated.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

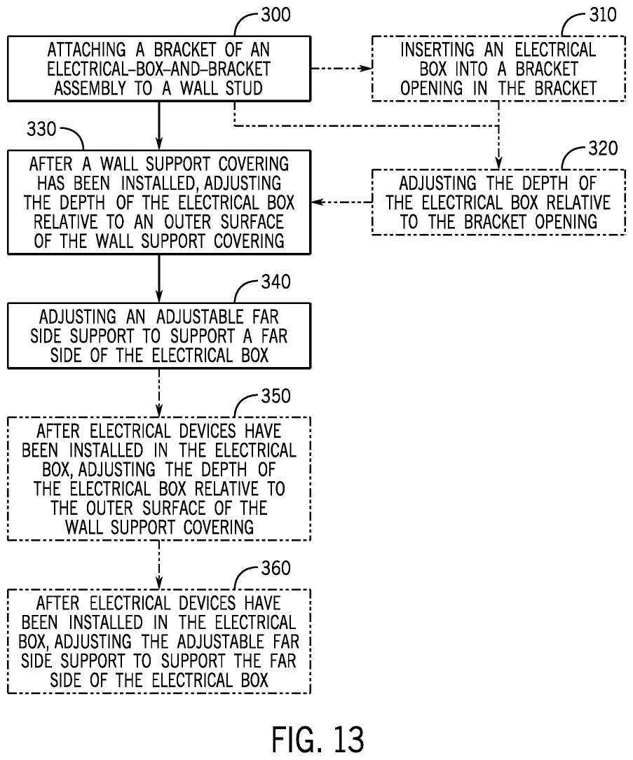

Correspondingly, FIG. 13 illustrates aspects of a method of securing and adjusting an electrical box and bracket assembly 100 according to an embodiment of the invention as described above. In the illustrated example, the relevant stud includes a front face that extends between two opposing side walls (the wall stud 10 shown in FIGS. 8 through 11), although other stud configurations are also contemplated (e.g., a metal stud with an open side and a closed side). As described above and shown in the corresponding figures, the electrical box and bracket assembly 100 includes an electrical box 102, a bracket 104, a first box adjustment fastener 138, a second box adjustment fastener 140, and an adjustable far side support 150. The bracket 104 includes a support body 106 with a bracket opening 108 formed therein, a first support arm 110 with an extension portion 114 and a support portion 118, a second support arm 112 with an extension portion 116 and a support portion 120, and a mounting flange 122. The electrical box 102 includes a front opening 124 and a rear wall 126, opposite the front opening 124, with a first threaded hole 132, a second threaded hole 134, and a third threaded hole 136. Further, the first box adjustment fastener 138 extends through the first threaded hole 132 and is configured to operably engage with the support portion 118 of the first support arm 110, the second box adjustment fastener 140 extends through the second threaded hole 134 and is configured to operably engage with the support portion 120 of the second support arm 112, and the adjustable far side support 150 extends through the third threaded hole 136. The method includes attaching 300 the bracket 104 of the electrical box and bracket assembly 100 to the wall stud 10 by affixing the mounting flange 122 of the bracket 104 to the front face 12 of the wall stud 10 (e.g., with fasteners (not shown)). If the electrical box 102 and the bracket 104 are not already combined when the bracket 104 is attached to the wall stud 10, the method can include inserting 310 the electrical box into the bracket opening 108. Optionally, adjusting 320 the depth of the electrical box 102 relative to the bracket opening 108 to a preferred depth by rotating the first and second box adjustment fasteners 138, 140. The method can also include, after a wall support covering 18 has been installed on the wall stud 10 and around the electrical box 102, adjusting 330 the depth of the electrical box 102 relative to the outer surface of the wall support covering 18 to position the front opening 124 flush with the outer surface of the wall support covering 18, and adjusting 340 the adjustable far side support 150 to contact the opposing wall support covering 26 to support the far side of the electrical box 102 and maintain the position of the front opening 124 flush with the outer surface of the wall support covering 18. The method can also include, after at least one electrical device (e.g., an electrical receptacle 14) has been installed in the electrical box 102, adjusting 350 the depth of the electrical box 102 relative to the outer surface of the wall support covering 18 to position the front opening 124 flush with the outer surface of the wall support covering 18, and adjusting 360 the adjustable far side support 150 to contact the opposing wall support covering 26 to support the far side of the electrical box 102 and maintain the position of the front opening 124 flush with the outer surface of the wall support covering 18.

The discussion above is framed relative to particular electrical boxes and brackets and associated arrangements. However, those of skill in the art will recognize that this discussion implicitly also discloses various methods of adjustably mounting electrical boxes relative to support structures. Similarly, as also discussed above, the particular configurations of the support bodies and other components expressly described and illustrated in the various embodiments are presented as examples only, and the concepts disclosed herein can be used to adjustably secure electrical boxes (or other components) relative to a variety of bracket configurations and support structures. In this regard, for example, brackets according to some embodiments can be configured for attachment to between-stud supports, as integral parts of between-stud supports, for attachment directly to building studs or other building structures, and so on. Further, specific features discussed in detail relative to certain embodiments can be generally configured or used similarly with other embodiments, including relative to similar features on those embodiments or as substitutions or additions to those embodiments.

Thus, embodiments of the invention can provide improved brackets for adjustable mounting of electrical boxes and securing of electrical boxes. For example, some embodiments can provide brackets that allow an electrical box to be adjusted among any number of different mounting depths relative to a support structure, including any number of different mounting depths along a continuous range of depths, and then secured against movement of the far side of the electrical box through adjustment an adjustable far side support.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

What is claimed is:

1. An electrical-box-and-bracket assembly comprising:
a bracket including a support body, with a bracket opening, and first and second support arms extending from the support body on opposing sides of the bracket opening; and
an electrical box having a front opening and positioned within the bracket opening; and
a set of adjustable fasteners, including first and second box adjustment fasteners and an adjustable far side support;
the first and second box adjustment fasteners extending through a rear wall of the electrical box and to the first and second support arms, the first and second box adjustment fasteners being accessible for selectively adjusting the distance between the bracket opening of the bracket and the front opening of the electrical box; and
the adjustable far side support extending through the rear wall of the electrical box and being accessible for adjustably supporting the electrical box.

2. The electrical-box-and-bracket assembly of claim 1, wherein the bracket includes a mounting flange for mounting the bracket to a wall stud.

3. The electrical-box-and-bracket assembly of claim 1, wherein the rear wall of the electrical box has a set of threaded holes, including a first threaded hole in which the first box adjustment fastener is threadingly engaged, a second threaded hole in which the second box adjustment fastener is threadingly engaged, and a third threaded hole in which the adjustable far side support is threadingly engaged.

4. The electrical-box-and-bracket assembly of claim 3, wherein the first threaded hole and the second threaded hole are located at diagonally opposite corners of the rear wall.

5. The electrical-box-and-bracket assembly of claim 3, wherein the bracket includes a mounting flange for mounting the bracket to a wall stud, and the third threaded hole is located in a corner of the rear wall on a side of the electrical box opposite the mounting flange.

6. The electrical-box-and-bracket assembly of claim 1, wherein the first and second box adjustable fasteners are axially fixed and rotatable, relative to the corresponding first or second support arm.

7. The electrical-box-and-bracket assembly of claim 1, wherein the first and second box adjustment fasteners and the adjustable far side support are accessible through the front opening for adjustment from inside the electrical box.

8. The electrical-box-and-bracket assembly of claim 7, further comprising:
electrical devices installed within the front opening of the electrical box;
wherein, with electrical devices installed, the first and second box adjustment fasteners and the adjustable far side support are accessible through the front opening for adjustment from inside the electrical box.

9. An electrical-box-and-bracket assembly comprising:
an electrical box having a rear wall with a set of threaded holes therein;
a bracket with a mounting flange for affixing the bracket to a support structure; and
a set of threaded fasteners including:
a first threaded fastener extending through a first threaded hole of the set of threaded holes and also engaged with the bracket to adjust a depth of the electrical box relative to the bracket;
a second threaded fastener extending through a second threaded hole of the set of threaded holes and configured to adjustably support a side of the electrical box opposite the mounting flange.

10. The electrical-box-and-bracket assembly of claim 9, wherein the first and second fasteners are accessible inside the electrical box for adjustment through a front opening of the electrical box.

11. The electrical-box-and-bracket assembly of claim 10, wherein the first and second threaded holes are located in different corners of the rear wall.

12. The electrical-box-and-bracket assembly of claim 10, wherein the bracket has a support arm extending from a support body of the bracket and along the electrical box, the first threaded fastener axially fixed and rotatable relative to the support arm.

13. The electrical-box-and-bracket of claim 12, wherein the support arm extends from a side of a bracket opening in which the electrical box is slidingly received.

14. The electrical-box-and-bracket of claim 12, wherein the support arm is a first support arm in a set of support arms also including a second support arm, the second support arm extending from a side of the bracket opening opposite the first support arm; and
the set of threaded fasteners further including a third threaded fastener extending through a third threaded hole of the set of threaded holes, the third threaded fastener axially fixed and rotatable relative to the second support arm.

15. The electrical-box-and-bracket of claim 14, wherein, with the electrical-box-and-bracket installed in a first wall having a first wall depth, the first support arm, the second support arm, and the second threaded fastener provide a three-point support for the electrical box; and
wherein, with the electrical-box-and-bracket installed in a second wall having a second wall depth greater than the first wall depth, the second threaded fastener is selectively adjustable to provide a one-point support for the electrical box.

16. A method of attaching an electrical-box-and-bracket assembly, including an electrical box and a bracket, to a support structure, the method comprising:
affixing a mounting flange of the bracket to the support structure;
adjusting the electrical box relative to the support structure by rotating a threaded fastener engaged between the electrical box and the bracket; and
adjusting an adjustable far side support to contact an opposing wall support covering to support a side of the electrical box distal to the support structure by rotating a second threaded fastener.

17. The method of claim 16, further comprising:
after a wall support covering has been installed on the support structure on which the electrical box-and-bracket assembly is affixed, rotating the threaded fastener to position a front opening of the electrical box flush with an outer surface of the wall support covering.

18. The method of claim 17, further comprising:
after positioning the front opening of the electrical box flush with the outer surface of the wall support covering, adjusting the adjustable far side support to maintain contact with the opposing wall support covering to secure the front opening in flush alignment with the outer surface of the wall support covering.

19. The method of claim 16, further comprising:
after an electrical device has been installed in the electrical box, rotating the threaded fastener to position a front opening of the electrical box flush with an outer surface of the wall support covering.

20. The method of claim 19, further comprising:
after positioning the front opening of the electrical box flush with the outer surface of the wall support covering, adjusting the adjustable far side support to maintain contact with the opposing wall support covering to secure the position of the front opening flush with the outer surface of the wall support covering.
